(19) United States
(12) Patent Application Publication
(10) Pub. No.: US 2025/0024253 A1
(43) Pub. Date: Jan. 16, 2025

(54) BLUETOOTH TRANSMITTING DEVICE, BLUETOOTH RECEIVING DEVICE AND BLUETOOTH PAIRING METHOD

(71) Applicant: REALTEK SEMICONDUCTOR CORPORATION, Hsinchu (TW)

(72) Inventor: YAN-ZHE WU, Suzhou (CN)

(21) Appl. No.: 18/767,394

(22) Filed: Jul. 9, 2024

(30) Foreign Application Priority Data
Jul. 10, 2023 (CN) 202310840434.1

(51) Int. Cl. H04W 12/043; H04W 12/041; H04W 12/06; H04W 12/50

(52) U.S. Cl. CPC H04W 12/043; H04W 12/041; H04W 12/06; H04W 12/50

(57) ABSTRACT

A Bluetooth transmitting device includes a key generating circuit, a calculating circuit, a storing circuit, and an encrypting and decrypting circuit. The key generating circuit generates a transmitting-terminal algorithm identifier, a receiving-terminal algorithm identifier, a public key, and a key length. The calculating circuit generates a transmitting-terminal authentication token, and receives a receiving-terminal authentication token of a Bluetooth receiving device to determine whether the receiving-terminal authentication token is within an additive cyclic group. If the receiving-terminal authentication token is within the additive cyclic group, the calculating circuit further calculates a transmitting-terminal session key according to the transmitting-terminal algorithm identifier, the receiving-terminal algorithm identifier, the transmitting-terminal authentication token, the receiving-terminal authentication token, and the key length. The storing circuit stores the transmitting-terminal session key. The encrypting and decrypting circuit calculates a ciphertext according to the transmitting-terminal session key, the public key, and the key length.

### BACKGROUND OF THE INVENTION

### 1. Field of the Invention

The present disclosure relates to a Bluetooth device and a Bluetooth operation method, especially to a Bluetooth transmitting device, a Bluetooth receiving device, and a Bluetooth pairing method.

### 2. Description of Related Art

When pairing Bluetooth devices in general, the two Bluetooth devices to be paired need to exchange their device types. Subsequently, based on different device types, different authentication processes are selected. During authentication, users are typically required to confirm the authentication through the device interface (such as a screen) to complete the pairing process among the two Bluetooth devices for establishing a Bluetooth connection between the two Bluetooth devices.

Since the two Bluetooth devices need to exchange their device types during the authentication process, a significant number of interactions between the two Bluetooth devices are generated, such that the power consumption of the two Bluetooth devices increases, and the standby time is consequently reduced. In addition, customers must participate in the above-mentioned authentication process, which results in inconvenience for the customers. Moreover, session keys are typically stored in a local file in a plaintext way, and various security concerns therefore occur.

### SUMMARY OF THE INVENTION

In some aspects, an object of the present disclosure is to, but not limited to, provide a Bluetooth transmitting device, a Bluetooth receiving device, and a Bluetooth pairing method that makes an improvement to the prior art.

An embodiment of the Bluetooth transmitting device of the present disclosure includes a key generating circuit, a calculating circuit, a storing circuit, and an encrypting and decrypting circuit. The key generating circuit is configured to generate a transmitting-terminal algorithm identifier, a receiving-terminal algorithm identifier, a public key, and a key length. The calculating circuit is configured to generate a transmitting-terminal authentication token, and receive a receiving-terminal authentication token of a Bluetooth receiving device to determine whether the receiving-terminal authentication token is within an additive cyclic group, wherein if the receiving-terminal authentication token is within the additive cyclic group, the calculating circuit is further configured to calculate a transmitting-terminal session key according to the transmitting-terminal algorithm identifier, the receiving-terminal algorithm identifier, the transmitting-terminal authentication token, the receiving-terminal authentication token, and the key length. The storing circuit is configured to store the transmitting-terminal session key. The encrypting and decrypting circuit is configured to calculate a ciphertext according to the transmitting-terminal session key, the public key, and the key length.

An embodiment of the Bluetooth receiving device of the present disclosure includes a key generating circuit, a calculating circuit, a storing circuit, and an encrypting and decrypting circuit. The key generating circuit is configured to generate a transmitting-terminal algorithm identifier, a receiving-terminal algorithm identifier, a public key, and a key length. The calculating circuit is configured to generate a receiving-terminal authentication token, and receive a transmitting-terminal authentication token of a Bluetooth transmitting device to determine whether the transmitting-terminal authentication token is within an additive cyclic group, wherein if the transmitting-terminal authentication token is within the additive cyclic group, the calculating circuit is further configured to calculate a receiving-terminal session key according to the transmitting-terminal algorithm identifier, the receiving-terminal algorithm identifier, the transmitting-terminal authentication token, the receiving-terminal authentication token, and the key length. The storing circuit is configured to store the receiving-terminal session key. The encrypting and decrypting circuit is configured to receive a ciphertext verification code of a ciphertext of the Bluetooth transmitting device to determine whether the ciphertext verification code is within the additive cyclic group, wherein if the ciphertext verification code is within the additive cyclic group, the encrypting and decrypting circuit is further configured to generate an encryption and decryption key and an address key according to the ciphertext verification code, the receiving-terminal session key, and the key length, wherein the encrypting and decrypting circuit is further configured to generate a plaintext and a data verification value respectively according to the encryption and decryption key and the address key, wherein if the encrypting and decrypting circuit determines that the data verification value is equal to a data check digit of the ciphertext, the encrypting and decrypting circuit outputs the plaintext.

An embodiment of the Bluetooth pairing method of the present disclosure includes generating a transmitting-terminal algorithm identifier by a Bluetooth transmitting device, generating a receiving-terminal algorithm identifier by a Bluetooth receiving device, and generating a public key and a key length by the Bluetooth transmitting device and the Bluetooth receiving device; calculating a transmitting-terminal session key and a receiving-terminal session key respectively according to the transmitting-terminal algorithm identifier, the receiving-terminal algorithm identifier, a transmitting-terminal authentication token, a receiving-terminal authentication token, and the key length by the Bluetooth transmitting device and the Bluetooth receiving device; calculating a ciphertext according to the transmitting-terminal session key, the public key, and the key length by the Bluetooth transmitting device; generating an encryption and decryption key and an address key according to a ciphertext verification code of the ciphertext, the receiving-terminal session key, and the key length by the Bluetooth receiving device; generating a plaintext and a data verification value according to the encryption and decryption key and the address key respectively by the Bluetooth receiving device; and if the data verification value is equal to a data check digit of the ciphertext, outputting the plaintext by the Bluetooth receiving device.

Technical features of some embodiments of the present disclosure make an improvement to the prior art. Compared to the prior art, technical features of some embodiments of the present disclosure decrease the number of interactions between two Bluetooth devices, such that the power consumption of the two Bluetooth devices decreases, and the standby time is consequently enhanced. In addition, the two Bluetooth devices of some embodiments of the present disclosure can automatically complete relevant steps between the two Bluetooth devices without participation of customers, which reduces inconvenience for customers. Moreover, session keys are stored in a storing circuit in a ciphertext way to decrease various security concerns.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a Bluetooth transmitting device and a Bluetooth receiving device of the present disclosure.

FIG. 2 shows an embodiment of a Bluetooth transmitting method of the present disclosure.

FIG. 3 shows an embodiment of a Bluetooth receiving method of the present disclosure.

FIG. 4 shows an embodiment of a Bluetooth pairing method of the present disclosure.

### DETAILED DESCRIPTION OF THE PREFERRED EMBODIMENTS

For solving a problem of high-power consumption resulting from extensive interactions between two Bluetooth devices, alleviating inconvenience caused by customers being involved in authentication processes, and decreasing security concerns associated with storing session keys in a plaintext way in the prior art, some embodiments of the present disclosure provide a Bluetooth transmitting device, a Bluetooth receiving device, and a Bluetooth pairing method, which will be explained in detail below.

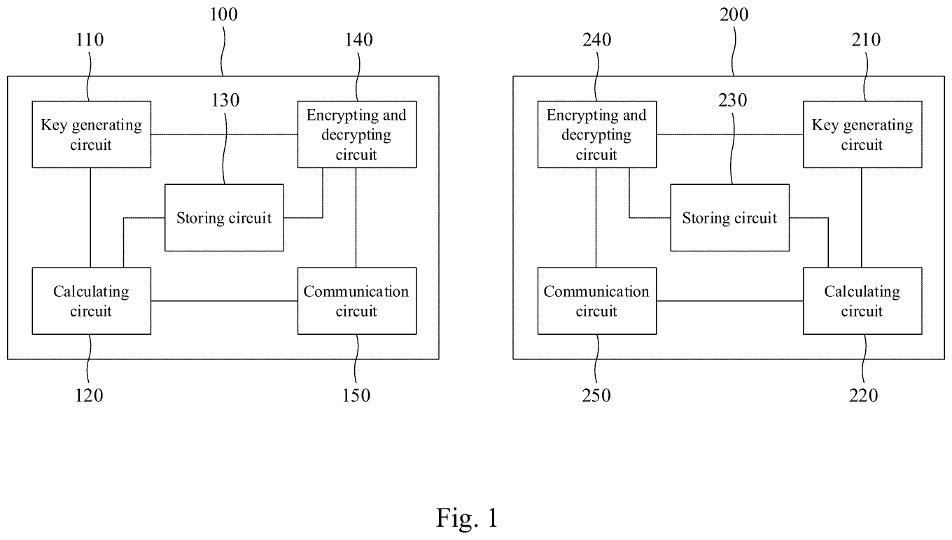

FIG. 1 shows an embodiment of a Bluetooth transmitting device 100 and a Bluetooth receiving device 200 of the present disclosure. The Bluetooth transmitting device 100 includes a key generating circuit 110, a calculating circuit 120, a storing circuit 130, an encrypting and decrypting circuit 140, and a communication circuit 150. In addition, the Bluetooth receiving device 200 includes a key generating circuit 210, a calculating circuit 220, a storing circuit 230, an encrypting and decrypting circuit 240, and a communication circuit 250.

As shown in the figure, the key generating circuit 110 is coupled to the calculating circuit 120 and the encrypting and decrypting circuit 140, the calculating circuit 120 is coupled to the storing circuit 130 and the communication circuit 150, and the encrypting and decrypting circuit 140 is coupled to the storing circuit 130 and the communication circuit 150. In addition, the key generating circuit 210 is coupled to the calculating circuit 220 and the encrypting and decrypting circuit 240, the calculating circuit 220 is coupled to the storing circuit 230 and the communication circuit 250, and the encrypting and decrypting circuit 240 is coupled to the storing circuit 230 and the communication circuit 250.

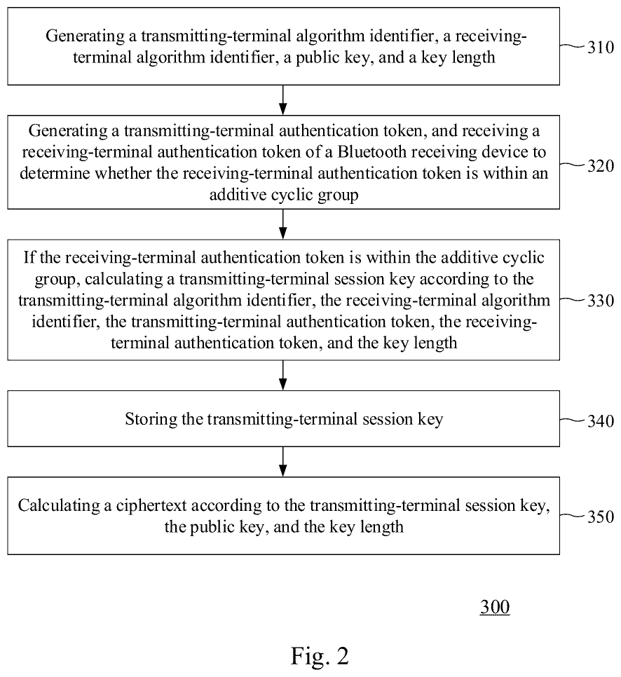

For facilitating the understanding of the operations of the Bluetooth transmitting device 100, please refer to FIG. 1 and FIG. 2. FIG. 2 shows an embodiment of a Bluetooth transmitting method 300 of the present disclosure.

Referring to step 310, the key generating circuit 110 is configured to generate a transmitting-terminal algorithm identifier ID_{A}, a receiving-terminal algorithm identifier ID_{B}, a public key P_{pub-e}, and a key length klen. For example, in this step, the key generating circuit 110 executes an initial process to a key exchange algorithm. First, the key generating circuit 110 confirms that the key length is klen bit, the transmitting-terminal algorithm identifier ID_{A} is a MAC (Media Access Control) address of the Bluetooth transmitting device 100, and the receiving-terminal algorithm identifier ID_{B} is a MAC address of the Bluetooth receiving device 200. In some embodiments, the MAC addresses of the Bluetooth transmitting device 100 and the Bluetooth receiving device 200 can be algorithm identifiers of the SM9 key negotiation algorithm.

In some embodiments, the MAC address of the Bluetooth transmitting device 100 can be the address of the Bluetooth transmitting device 100 itself, the MAC address of the Bluetooth receiving device 200 can be obtained from the advertising packet of the Bluetooth transmitting device 100. The key generating circuit 110 generates a random number ke as a transmitting-terminal master private key de_{A}, and the random number ke ranges from 1 to N−1. N is a prime number, and N is the order of the additive cyclic group G₁. The additive cyclic group G₁ will be explained in detail below. In addition, the key generating circuit 110 executes a [ke]P₁ calculation to obtain a public key P_{pub-e} as a corresponding value. P₁ is a generator of the additive cyclic group G₁, and the value is predefined. The key generating circuit 110 securely stores the transmitting-terminal master private key de_{A}, but makes the public key P_{pub-e} public. In some embodiments, the key generating circuit 110 can be a key generation center (KGC). In some embodiments, the Bluetooth transmitting method 300 of the present disclosure can adopt the SM9 key negotiation algorithm.

Referring to step 320, the calculating circuit 120 of the Bluetooth transmitting device 100 is configured to generate a transmitting-terminal authentication token R_{A}, and receive a receiving-terminal authentication token R_{B} of the Bluetooth receiving device 200 to determine whether the receiving-terminal authentication token R_{B} is within the additive cyclic group G₁. For example, in this step, the Bluetooth transmitting device 100 and the Bluetooth receiving device 200 begin an authentication process. The transmitting-terminal authentication token R_{A} and the receiving-terminal authentication token R_{B} are generated respectively by the calculating circuit 120 of the Bluetooth transmitting device 100 and the calculating circuit 220 of the Bluetooth receiving device 200 for the purpose of mutual authentication between the Bluetooth transmitting device 100 and the Bluetooth receiving device 200.

In some embodiments, the generation process of the transmitting-terminal authentication token R_{A} will be described below. The calculating circuit 120 generates the transmitting-terminal random number r_{A}, and the transmitting-terminal random number r_{A} ranges from 1 to N−1. N is a prime number, and N is the order of the additive cyclic group G₁. Subsequently, the calculating circuit 120 executes a cryptographic hash function calculation according to the receiving-terminal algorithm identifier ID_{B}, the first generator P₁, and the public key P_{pub-e} to calculate a parameter Q_{B}, and the calculation formula is as follows:

$${Q}_{B} = [ {H}_{1} ( I {D}_{B} \vert \vert hid , N ) ] {P}_{1} + {P}_{pub - e} \qquad formula 1$$

The H₁(Z,n) described in the formula 1 is a cryptographic hash function approved by the national cryptographic authority, the inputs are a bit string Z and an integer N, the output is an integer h₁, and it ranges from 1 to N−1. N is a prime number, and N is the order of the additive cyclic group G₁. The hid described in the formula 1 is a signature private key generation function identifier which is represented by a byte, and the hid is publicly generated by the key generation circuit 110. N is the upper limit of the random number range specified by the key generation circuit 110, and its value is made public. P₁ is the generator of the additive cyclic group G₁, and G₁ is an additive cyclic group with an order that is a prime number N. The calculation steps of H₁(Z,n) are as follows:
step a: Initialize a 32-bit counter ct=0x00000001;
step b: Calculate hlen=8x[(5x(log₂ⁿ))/32];
step c: Execute for i from 1˜┌hlen/v┐, calculate Haᵢ=Hᵥ(0x01∥Z∥ct), calculate ct++. The output of the Hv( ) is a hash value with length v bits, and the hash value can be referenced from the cryptographic hash functions approved by the national cryptographic authority, GB/T 32905;
step d: If hlen/v is an integer, let Ha!_{┌hlen/v┐}=Ha_{┌hlen/v┐}, otherwise, let Ha!_{┌hlen/v┐} be the leftmost (hlen−(v×└hlen/v┘)) bits of Ha_{┌hlen/v┐};
step e: Ha=Ha₁∥Ha₂∥ . . . ∥Ha_{┌hlen/v┐-1}∥Ha!_{┌hlen/v┐-1}, convert the data type of Ha to an integer as specified in detail in GB/T 38635.1-2020 sections 7.2.4 and 7.2.3.; and
step f: Finally, the output value h₁ of the H₁(Z, n) is calculated as Ha mod (n−1))+1.

After obtaining the parameter Q_{B}, the calculating circuit 120 calculates the transmitting-terminal authentication token R_{A} according to the transmitting-terminal random number r_{A} and the parameter Q_{B}. Subsequently, the communication circuit 150 transmits the transmitting-terminal authentication token R_{A} to the Bluetooth receiving device 200 for authentication. The calculation formula is as follows:

$${R}_{A} = [ {r}_{A} ] {Q}_{B} \qquad formula 2$$

Referring to step 330, if the receiving-terminal authentication token R_{B} is within the additive cyclic group G₁, the calculating circuit 120 is configured to calculate a transmitting-terminal session key SK_{A} according to the transmitting-terminal algorithm identifier ID_{A}, the receiving-terminal algorithm identifier ID_{B}, the transmitting-terminal authentication token R_{A}, the receiving-terminal authentication token R_{B}, and the key length klen. For example, in this step, the Bluetooth transmitting device 100 and the Bluetooth receiving device 200 negotiate the session key SK_{A}. If the calculating circuit 120 of the Bluetooth transmitting device 100 determines that the receiving-terminal authentication token R_{B} transmitted from the Bluetooth receiving device 200 is within the additive cyclic group G₁, the authentication is successful (i.e., the authentication is completed). At the same time, the calculating circuit 120 calculates the transmitting-terminal session key SK_{A} according to the transmitting-terminal algorithm identifier ID_{A}, the receiving-terminal algorithm identifier ID_{B}, the transmitting-terminal authentication token R_{A}, the receiving-terminal authentication token R_{B}, and the key length klen. On the other hand, if the receiving-terminal authentication token R_{B} is not within the additive cyclic group G₁, the authentication fails.

In some embodiments, the calculation process of the transmitting-terminal authentication token SK_{A} is described below. The calculating circuit 120 executes a bilinear pairing calculation according to the public key P_{pub-e}, a second generator P₂, and the transmitting-terminal random number r_{A} to calculate a first element g₁′, and the calculation formula is as follows:

$${g}_{1}^{′} = {e ( {P}_{pub - e} , {P}_{2} )}_{A}^{r} \qquad formula 3$$

Subsequently, the calculating circuit 120 executes the bilinear pairing calculation according to the receiving-terminal authentication token R_{B} and the transmitting-terminal master private key de to calculate the second element g₂′, and the calculation formula is as follows:

$${g}_{2}^{′} = e ( {R}_{B} , {de}_{A} ) \qquad formula 4$$

Subsequently, the calculating circuit 120 calculates a third element g₃′ according to the second element g₂′ and the transmitting-terminal random number r_{A}, and the calculation formula is as follows:

$${g}_{3}^{′} = {( {g}_{2}^{′} )}_{A}^{r} \qquad formula 5$$

In addition, the calculating circuit 120 executes a key derivation calculation according to the transmitting-terminal algorithm identifier ID_{A}, the receiving-terminal algorithm identifier ID_{B}, the transmitting-terminal authentication token R_{A}, the receiving-terminal authentication token R_{B}, the first element g₁′, the second element g₂′, the third element g₃′, and the key length klen to calculate the transmitting-terminal session key SK_{A}, and the calculation formula is as follows:

$${SK}_{A} = KDF ( {ID}_{A} ‖ {ID}_{B} ‖ {R}_{A} ‖ {R}_{B} ‖ {g}_{1}^{′} ‖ {g}_{2}^{′} ‖ {g}_{3}^{′} , klen ) \qquad formula 6$$

The KDF as shown in the formula 6 is the key derivation function defined in the SM9 algorithm. The calculation steps of the KDF are as follows:
step a: Initialize a 32-bit counter ct-0x00000001;
step b: Execute for i from 1˜┌klen/v┐, calculate Haᵢ=Hᵥ(Z∥ct), ct++;
step c: If klen/v is an integer, let Ha!_{┌klen/v┐}=Ha_{┌klen/v┐}, Otherwise, let Ha!_{┌klen/v┐} be the leftmost (klen−(v×└klen/v┘)) bits of Ha_{┌klen/v┐}; and
step d: Finally, K=Ha₁∥Ha₂∥ . . . ∥Ha_{┌klen/v┐-1}∥Ha!_{┌klen/v┐-1} is outputted to be the output value of KDF.

Referring to step 340, the storing circuit 130 is configured to store the transmitting-terminal session key SK_{A}. For example, after the calculating circuit 120 of the Bluetooth transmitting device 100 calculates the transmitting-terminal session key SK_{A}, the transmitting-terminal session key SK_{A} will be stored in the storing circuit 130. The key stored in the storing circuit 130 is non-persistent, and the security of the Bluetooth communication is therefore ensured.

Referring to step 350, the encrypting and decrypting circuit 140 is configured to calculate a ciphertext C according to the transmitting-terminal session key SK_{A}, the public key P_{pub-e}, and the key length klen. For example, in this step, after the Bluetooth transmitting device 100 and the Bluetooth receiving device 200 complete the authentication, the encrypting and decrypting circuit 140 of the Bluetooth transmitting device 100 executes an encrypted communication by using the transmitter session key SK_{A}. The calculation process of the ciphertext C used in the encrypted communication will be described below.

First, the key generating circuit 110 initializes the key exchange algorithm, and the transmitting-terminal session key SK_{A} is used as the algorithm identifier. Subsequently, the encrypting and decrypting circuit 140 executes the cryptographic hash function calculation according to the transmitting-terminal session key SK_{A}, the first generator P₁, and the public key P_{pub-e} to calculate a parameter Q_{B}′, and the calculation formula is as follows:

$${Q}_{B}^{′} = [ {H}_{1} ( {SK}_{A} \vert \vert hid , N ) ] {P}_{1} + {P}_{pub - e} \qquad formula 7$$

The H₁(Z,n), hid, and N in the formula 7 are described in the formula 1, and they will not be elaborated further herein.

Subsequently, the encrypting and decrypting circuit 140 generates an encrypting and decrypting random number r, and the encrypting and decrypting random number r ranges from 1 to N−1. N is a prime number, and N is the order of the additive cyclic group G₁. The encrypting and decrypting circuit 140 calculates a ciphertext verification code C₁ according to the encrypting and decrypting random number r and the parameter Q_{B}′, and the calculation formula is as follows:

$${C}_{1} = [ r ] {Q}_{B}^{′} \qquad formula 8$$

The encrypting and decrypting circuit 140 executes the bilinear pairing calculation according to the public key P_{pub-e} and the second generator P₂ to calculate a fourth element g, and the calculation formula is as follows:

$$g = e ( {P}_{pub - e} , {P}_{2} ) \qquad formula 9$$

Subsequently, the encrypting and decrypting circuit 140 calculates a fifth element ω according to the fourth element g and the encrypting and decrypting random number r, and the calculation formula is as follows:

$$ω = {g}^{r} \qquad formula 10$$

Subsequently, the encrypting and decrypting circuit 140 calculates a key length klen according to a plaintext data length mlen and a message authentication code length K₂_len, wherein the message authentication code length K₂_len is a key length of a message authentication function MAC and is a predefined value. The calculation formula is as follows:

$$klen = mlen + {K}_{2} \_len \qquad formula 11$$

In addition, the encrypting and decrypting circuit 140 executes the key derivation calculation according to the ciphertext verification code C₁, the fifth element ω, the transmitting-terminal session key SK_{A}, and the key length klen to calculate a symmetric encryption key length K₁ and a message authentication code key length K₂, and the calculation formula is as follows:

$$K = KDF ( {C}_{1} ‖ ω ‖ {SK}_{A} , klen ) \qquad formula 12$$

Referring to formula 12, the symmetric encryption key length K₁ is the leftmost mlen length value of K, and the message authentication code key length K₂ is the remaining K₂ len value. In addition, KDF in the formula 12 is described in the formula 6, and it will not be elaborated further herein.

Subsequently, the encrypting and decrypting circuit 140 executes the symmetric encryption calculation according to the symmetric encryption key length K₁ and the plaintext M to calculate a ciphertext data C₂, and the calculation formula is as follows:

$${C}_{2} = Enc ( {K}_{1} , M ) \qquad formula 13$$

Referring to formula 13, Enc is an advanced encryption standard (AES) chosen by the Bluetooth transmitting device 100 and the Bluetooth receiving device 200, and the AES here can be a publicly symmetric encryption algorithm.

Subsequently, the encrypting and decrypting circuit 140 executes the message authentication code calculation according to the message authentication code key length K₂ and the ciphertext data C₂ to calculate a message authentication code C₃, and the calculation formula is as follows:

$${C}_{3} = MAC ( {K}_{2} , {C}_{2} ) \qquad formula 14$$

The MAC in the formula 14 is a message authentication code function, and it is used to verify data integrity.

In addition, the encrypting and decrypting circuit 140 calculates the ciphertext C according to the ciphertext verification code C₁, the ciphertext data C₂, and the message authentication code C₃, and the communication circuit 150 then transmits the ciphertext C to the Bluetooth receiving device 200. The calculation formula is as follows:

$$C = {C}_{1} ‖ {C}_{3} ‖ {C}_{2} \qquad formula 15$$

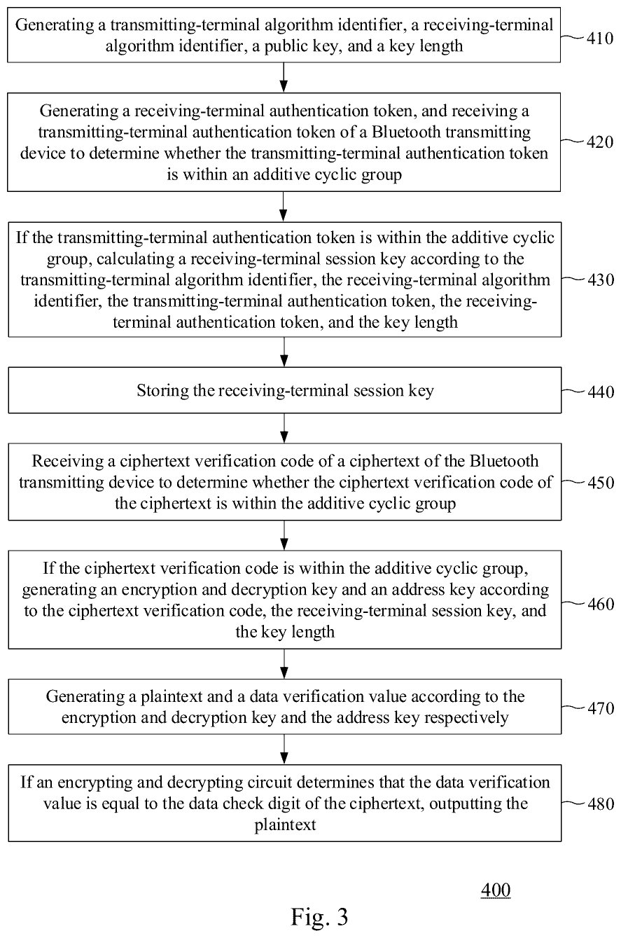

For facilitating the understanding of the operations of the Bluetooth receiving device 200, please refer to FIG. 1 and FIG. 3. FIG. 3 shows an embodiment of a Bluetooth receiving method 400 of the present disclosure.

Referring to step 410, the key generating circuit 210 is configured to generate a transmitting-terminal algorithm identifier ID_{A}, a receiving-terminal algorithm identifier ID_{B}, a public key P_{pub-e}, and a key length klen. For example, in this step, the key generating circuit 210 executes an initial process to a key exchange algorithm. First, the key generating circuit 210 confirms that the key length is klen bit, a MAC (Media Access Control) address of the Bluetooth transmitting device 100 is the transmitting-terminal algorithm identifier ID_{A}, and a MAC address of the Bluetooth receiving device 200 is the receiving-terminal algorithm identifier ID_{B}. In some embodiments, the MAC addresses of the Bluetooth transmitting device 100 and the Bluetooth receiving device 200 can be algorithm identifiers of the SM9 key negotiation algorithm.

In some embodiments, the MAC address of the Bluetooth receiving device 200 can be the address of the Bluetooth receiving device 200 itself, the MAC address of the Bluetooth transmitting device 100 can be obtained from an air link connection request packet of the Bluetooth transmitting device 100. The key generating circuit 210 generates a random number ke as a receiving-terminal master private key des, and the random number ke ranges from 1 to N−1. Nis a prime number, and Nis the order of the additive cyclic group G₁. In some embodiments, the key generating circuit 210 can be a key generation center (KGC). In some embodiments, the Bluetooth receiving method 400 of the present disclosure can adopt the SM9 key negotiation algorithm.

Referring to step 420, the calculating circuit 220 of the Bluetooth receiving device 200 is configured to generate a receiving-terminal authentication token R_{B}, and receive a transmitting-terminal authentication token R_{A} of the Bluetooth transmitting device 100 to determine whether the transmitting-terminal authentication token R_{A} is within the additive cyclic group G₁. For example, in this step, the Bluetooth transmitting device 100 and the Bluetooth receiving device 200 begin an authentication process. The transmitting-terminal authentication token R_{A} and the receiving-terminal authentication token R_{B} are generated respectively by the calculating circuit 120 of the Bluetooth transmitting device 100 and the calculating circuit 220 of the Bluetooth receiving device 200 for the purpose of mutual authentication between the Bluetooth transmitting device 100 and the Bluetooth receiving device 200.

In some embodiments, the generation process of the receiving-terminal authentication token R_{B} will be described below. The calculating circuit 220 generates the receiving-terminal random number r_{B}, and the receiving-terminal random number rs ranges from 1 to N−1. N is a prime number, and N is the order of the additive cyclic group G₁. Subsequently, the calculating circuit 220 executes a cryptographic hash function calculation according to the transmitting-terminal algorithm identifier ID_{A}, the first generator P₁, and the public key P_{pub-e} to calculate a parameter Q_{A}, and the calculation formula is as follows:

$${Q}_{A} = [ {H}_{1} ( {ID}_{A} \vert \vert hid , N ) ] {P}_{1} + {P}_{pub - e} \qquad formula 16$$

The H₁(Z,n), hid, and N in the formula 16 are described in the formula 1, and they will not be elaborated further herein.

After obtaining the parameter Q_{A}, the calculating circuit 220 calculates the receiving-terminal authentication token R_{B} according to the receiving-terminal random number TB and the parameter Q_{A}. Subsequently, the communication circuit 250 transmits the receiving-terminal authentication token R_{B} to the Bluetooth transmitting device 100 for authentication. The calculation formula is as follows:

$${R}_{B} = [ {r}_{B} ] {Q}_{A} \qquad formula 17$$

Referring to step 430, if the transmitting-terminal authentication token R_{A} is within the additive cyclic group G₁, the calculating circuit 220 is configured to calculate a receiving-terminal session key SK_{B} according to the transmitting-terminal algorithm identifier ID_{A}, the receiving-terminal algorithm identifier ID_{B}, the transmitting-terminal authentication token R_{A}, the receiving-terminal authentication token R_{B}, and the key length klen. For example, in this step, the Bluetooth transmitting device 100 and the Bluetooth receiving device 200 negotiate the receiving-terminal session key SK_{B}. If the calculating circuit 220 of the Bluetooth receiving device 200 determines that the transmitting-terminal authentication token R_{A} transmitted from the Bluetooth transmitting device 100 is within the additive cyclic group G₁, the authentication is successful (i.e., the authentication is completed). At the same time, the calculating circuit 220 calculates the transmitting-terminal session key SK_{B} according to the transmitting-terminal algorithm identifier ID_{A}, the receiving-terminal algorithm identifier ID_{B}, the transmitting-terminal authentication token R_{A}, the receiving-terminal authentication token R_{B}, and the key length klen. On the other hand, if the transmitting-terminal authentication token R_{A} is not within the additive cyclic group G₁, the authentication fails.

In some embodiments, the calculation process of the transmitting-terminal authentication token SK_{B} is described below. The calculating circuit 220 executes a bilinear pairing calculation according to the transmitting-terminal authentication token R_{A} and the receiving-terminal master private key des to calculate a first element g₁, and the calculation formula is as follows:

$${g}_{1} = e ( {R}_{A} , {de}_{B} ) \qquad formula 18$$

Subsequently, the calculating circuit 220 executes the bilinear pairing calculation according to the public key P_{pub-e}, the second generator P₂, and the receiving-terminal random number re to calculate a second element g₂, and the calculation formula is as follows:

$${g}_{2} = e ( {P}_{pub - e} , {P}_{2} ) {r}_{B} \qquad formula 19$$

Subsequently, the calculating circuit 220 calculates a third element g₃ according to the first element g₁ and the receiving-terminal random number r_{B}, and the calculation formula is as follows:

$${g}_{3} = {{g}_{1}^{r}}_{B} \qquad formula 20$$

Subsequently, the calculating circuit 220 executes a key derivation calculation according to the transmitting-terminal algorithm identifier ID_{A}, the receiving-terminal algorithm identifier ID_{B}, the transmitting-terminal authentication token R_{A}, the receiving-terminal authentication token R_{B}, the first element g₁, the second element g₂, the third element g₃, and the key length klen to calculate the receiving-terminal session key SK_{B}, and the calculation formula is as follows:

$${SK}_{B} = KDF ( {ID}_{A} ‖ {ID}_{B} ‖ {R}_{A} ‖ {R}_{B} ‖ {g}_{1} ‖ {g}_{2} ‖ {g}_{3} , klen ) \qquad formula 21$$

KDF in the formula 21 is described in the formula 6, and it will not be elaborated further herein.

Referring to step 440, the storing circuit 230 is configured to store the receiving-terminal session key SK_{B}. For example, after the calculating circuit 220 of the Bluetooth receiving device 200 calculates the receiving-terminal session key SK_{B}, the receiving-terminal session key SK_{B} will be stored in the storing circuit 230. The key stored in the storing circuit 230 is non-persistent, and the security of the Bluetooth communication is therefore ensured.

Referring to step 450, the encrypting and decrypting circuit 240 is configured to receive a ciphertext verification code C₁ of a ciphertext C of the Bluetooth transmitting device 200 to determine whether the ciphertext verification code C₁ of the ciphertext C is within the additive cyclic group G₁. For example, in this step, after the communication device 250 of the Bluetooth receiving device 200 receives the ciphertext C transmitted from the Bluetooth transmitting device 100, the communication device 250 transmits the ciphertext C to the encrypting and decrypting circuit 240 for executing a decrypting process. Subsequently, the encrypting and decrypting circuit 240 determines whether the ciphertext verification code C₁ of the ciphertext C is within the additive cyclic group G₁.

Referring to step 460, if the ciphertext verification code C₁ is within the additive cyclic group G₁, the encrypting and decrypting circuit 240 is configured to generate an encryption and decryption key K₁′ and an address key K₂′ according to the ciphertext verification code C₁, the receiving-terminal session key SK_{B}, and the key length klen.

In some embodiments, the generation process of the encryption and decryption key K₁′ and the address key K₂′ will be described below. The encrypting and decrypting circuit 240 executes the bilinear pairing calculation according to the ciphertext verification code C₁ and the receiving-terminal master private key des to calculate a fourth element ω′, and the calculation formula is as follows:

$${ω}^{′} = e ( {C}_{1} , {de}_{B} ) \qquad formula 22$$

Subsequently, the encrypting and decrypting circuit 240 calculates a key length klen according to a ciphertext data length K₁_len and a message authentication code length K₂ len. The message authentication code length K₂_len is a key length of a message authentication function MAC and is a predefined value. The calculation formula is as follows:

$$klen = {K}_{1 \_} len + {K}_{2 \_} len \qquad formula 23$$

Subsequently, the encrypting and decrypting circuit 240 generates the encryption and decryption key K₁′ and the address key K₂′ according to the ciphertext verification code C₁, the fourth element ω′, the receiving-terminal session key SK_{B}, and the key length klen, and the calculation formula is as follows:

$${K}^{′} = KDF ( {C}_{1} ‖ {ω}^{′} ‖ {SK}_{B} , klen ) \qquad formula 24$$

Referring to formula 24, the symmetric encryption key length K₁′ is the leftmost K₁_len length value of K′, and the message authentication code key length K₂′ is the remaining K₂_len value. In addition, KDF in the formula 24 is described in the formula 6, and it will not be elaborated further herein.

Referring to step 470, the encrypting and decrypting circuit 240 is configured to generate a plaintext M′ and a data verification value u according to the encryption and decryption key K₁′ and the address key K₂′ respectively, and the calculation formula is as follows:

$${M}^{′} = Dec ( {K}_{1}^{′} , {C}_{2} ) \qquad formula 25$$

Dec in the formula 25 is a symmetric encryption and decryption function.

$$u = MAC ( {K}_{2}^{′} , {C}_{2} ) \qquad formula 26$$

MAC in the formula 26 is described in the formula 14, and it will not be elaborated further herein.

Referring to step 480, if the encrypting and decrypting circuit 240 determines that the data verification value u is equal to the data check digit C₃ of the ciphertext C, the encrypting and decrypting circuit 240 outputs the plaintext M′. For example, in this step, the encrypting and decrypting circuit 240 executes a data integrity verification. First, the encrypting and decrypting circuit 240 obtains the data check digit C₃ from the ciphertext C. Subsequently, the encrypting and decrypting circuit 240 determines whether the data verification value u is equal to the data check digit C₃ of the ciphertext C. If they are equal, the encrypting and decrypting circuit 240 outputs the plaintext M′. Conversely, if the encrypting and decrypting circuit 240 determines that the data verification value u is not equal to the data check digit C₃ of the ciphertext C, it reports an error and terminates the Bluetooth receiving method 400.

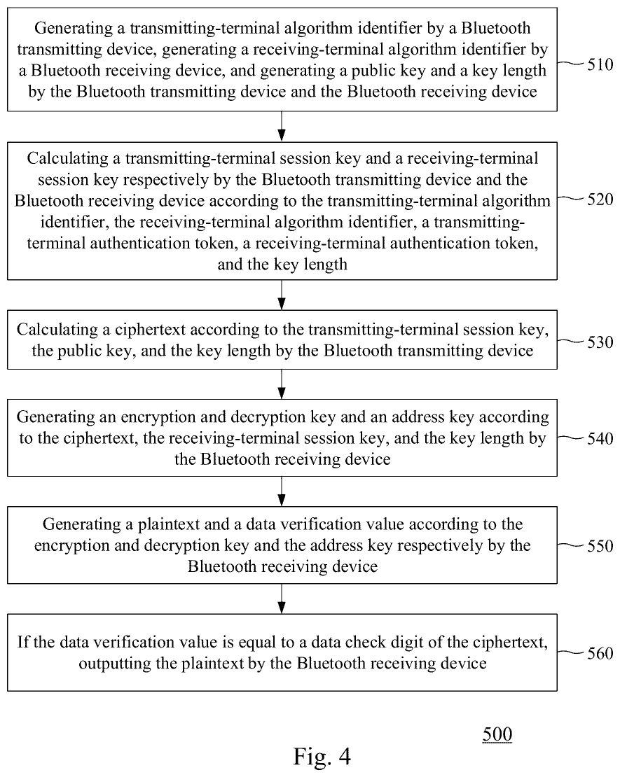

FIG. 4 shows an embodiment of a Bluetooth pairing method 500 of the present disclosure. For facilitating the understanding of the operations of the Bluetooth pairing method 500, please refer to FIG. 1 and FIG. 4.

Referring to step 510, the Bluetooth transmitting device 100 is configured to generate a transmitting-terminal algorithm identifier ID_{A}, the Bluetooth receiving device 200 is configured to generate a receiving-terminal algorithm identifier ID_{B}, and the Bluetooth transmitting device 100 and the Bluetooth receiving device 200 are configured to generate a public key P_{pub-e} and a key length klen. For example, in this step, the Bluetooth transmitting device 100 and the Bluetooth receiving device 200 are configured to execute initial processes to key exchange algorithms respectively. First, the Bluetooth transmitting device 100 and the Bluetooth receiving device 200 confirm that the key length is klen bit, a MAC (Media Access Control) address of the Bluetooth transmitting device 100 is the transmitting-terminal algorithm identifier ID_{A}, and a MAC address of the Bluetooth receiving device 200 is the receiving-terminal algorithm identifier ID_{B}. In some embodiments, the MAC addresses of the Bluetooth transmitting device 100 and the Bluetooth receiving device 200 can be algorithm identifiers of the SM9 key negotiation algorithm.

Referring to step 520, the Bluetooth transmitting device 100 and the Bluetooth receiving device 200 are configured to respectively calculate a transmitting-terminal session key SK_{A} and a receiving-terminal session key SK_{B} according to the transmitting-terminal algorithm identifier ID_{A}, the receiving-terminal algorithm identifier ID_{B}, the transmitting-terminal authentication token R_{A}, the receiving-terminal authentication token R_{B}, and the key length klen. For example, in this step, the Bluetooth transmitting device 100 and the Bluetooth receiving device 200 negotiate the transmitting-terminal session key SK_{A} and the receiving-terminal session key SK_{B}. The Bluetooth transmitting device 100 and the Bluetooth receiving device 200 respectively calculate the transmitting-terminal session key SK_{A} and the receiving-terminal session key SK_{B} according to the transmitting-terminal algorithm identifier ID_{A}, the receiving-terminal algorithm identifier ID_{B}, the transmitting-terminal authentication token R_{A}, the receiving-terminal authentication token R_{B}, and the key length klen. In some embodiments, the calculation process of the transmitting-terminal authentication token R_{A} is explained in the descriptions related to the formula 1 and the formula 2, the calculation process of the receiving-terminal authentication token R_{B} is explained in the descriptions related to related to the formula 16 and the formula 17, the transmitting-terminal session key SK_{A} is explained in the descriptions related to the formula 3 to the formula 6, the calculation process of the receiving-terminal session key SK_{B} is explained in the descriptions related to the formula 18 to the formula 21, and they will not be elaborated further herein.

Referring to step 530, the Bluetooth transmitting device 100 is configured to calculate the ciphertext C according to the transmitting-terminal session key SK_{A}, the public key P_{pub-e}, and the key length klen. For example, in this step, the Bluetooth transmitting device 100 uses parameters such as the session key SK_{A} to calculate the ciphertext C for executing an encrypted communication. In some embodiments, the calculation process of the ciphertext C is explained in the descriptions related to the formula 7 to the formula 15, and it will not be elaborated further herein.

Referring to step 540, the Bluetooth receiving device 200 is configured to generate an encryption and decryption key K₂′ and an address key K₂′ according to the ciphertext C, the receiving-terminal session key SK_{B}, and the key length klen. In some embodiments, the calculation processes of the encryption and decryption key K₁′ and the address key K₂′ are explained in the descriptions related to the formula 22 to the formula 24, and they will not be elaborated further herein.

Referring to step 550, the Bluetooth receiving device 200 is configured to respectively generate a plaintext M′ and a data verification value u according to the encryption and decryption key K₁′ and the address key K₂′. In some embodiments, the calculation processes of the plaintext M′ and the data verification value u are explained in the descriptions related to the formula 25 and the formula 26, and they will not be elaborated further herein. Referring to step 560, if the data verification value u is equal to the data check digit C₃ of the ciphertext C, the Bluetooth receiving device 200 outputs the plaintext M′. For example, in this step, the Bluetooth receiving device 200 executes a data integrity verification. First, the Bluetooth receiving device 200 obtains the data check digit C₃ from the ciphertext C. Subsequently, the Bluetooth receiving device 200 determines whether the data verification value u is equal to the data check digit C₃ of the ciphertext C. If they are equal, the Bluetooth receiving device 200 outputs the plaintext M′. Conversely, if the Bluetooth receiving device 200 determines that the data verification value u is not equal to the data check digit C₃ of the ciphertext C, it reports an error and terminates the Bluetooth pairing method 500.

As described above, some embodiments of the present disclosure provide the Bluetooth transmitting device 100, the Bluetooth receiving device 200, the Bluetooth transmitting method 300, the Bluetooth receiving method 400, and the Bluetooth pairing method 500 to decrease the number of interactions between two Bluetooth devices, such that the power consumption of the two Bluetooth devices decreases, and the standby time is consequently enhanced. In addition, the two Bluetooth devices of some embodiments of the present disclosure can automatically complete relevant steps between the two Bluetooth devices without participation of customers, which reduces inconvenience for customers. Moreover, session keys are stored in a storing circuit in a ciphertext way to decrease various security concerns.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A Bluetooth transmitting device, comprising:
a key generating circuit, configured to generate a transmitting-terminal algorithm identifier, a receiving-terminal algorithm identifier, a public key, and a key length;
a calculating circuit, configured to generate a transmitting-terminal authentication token, and receive a receiving-terminal authentication token of a Bluetooth receiving device to determine whether the receiving-terminal authentication token is within an additive cyclic group, wherein if the receiving-terminal authentication token is within the additive cyclic group, the calculating circuit is further configured to calculate a transmitting-terminal session key according to the transmitting-terminal algorithm identifier, the receiving-terminal algorithm identifier, the transmitting-terminal authentication token, the receiving-terminal authentication token, and the key length;
a storing circuit, configured to store the transmitting-terminal session key; and
an encrypting and decrypting circuit, configured to calculate a ciphertext according to the transmitting-terminal session key, the public key, and the key length.

2. The Bluetooth transmitting device of claim 1, wherein the calculating circuit is further configured to generate a transmitting-terminal random number, and execute a cryptographic hash function calculation according to the receiving-terminal algorithm identifier, a first generator, and the public key to calculate a first parameter, wherein the calculating circuit is further configured to calculate the transmitting-terminal authentication token according to the transmitting-terminal random number and the first parameter.

3. The Bluetooth transmitting device of claim 2, wherein the key generating circuit is further configured to generate a transmitting-terminal master private key, wherein the calculating circuit is further configured to execute a bilinear pairing calculation according to the public key, a second generator, and the transmitting-terminal random number to calculate a first element, execute the bilinear pairing calculation according to the receiving-terminal authentication token, and the transmitting-terminal master private key to calculate a second element, and calculate a third element according to the second element and the transmitting-terminal random number.

4. The Bluetooth transmitting device of claim 3, wherein the calculating circuit is further configured to execute a key derivation calculation according to the transmitting-terminal algorithm identifier, the receiving-terminal algorithm identifier, the transmitting-terminal authentication token, the receiving-terminal authentication token, the first element, the second element, the third element, and the key length to calculate the transmitting-terminal session key.

5. The Bluetooth transmitting device of claim 4, wherein the encrypting and decrypting circuit is further configured to execute the cryptographic hash function calculation according to the transmitting-terminal session key, the first generator, and the public key to calculate a second parameter, wherein the encrypting and decrypting circuit is further configured to generate an encrypting and decrypting random number, and calculate a ciphertext verification code according to the encrypting and decrypting random number and the second parameter.

6. The Bluetooth transmitting device of claim 5, wherein the encrypting and decrypting circuit is further configured to execute the bilinear pairing calculation according to the public key and the second generator to calculate a fourth element, wherein the encrypting and decrypting circuit is further configured to calculate a fifth element according to the fourth element and the encrypting and decrypting random number, wherein the encrypting and decrypting circuit s further configured to calculate the key length according to a plaintext data length and a message authentication code length, wherein the encrypting and decrypting circuit is further configured to execute the key derivation calculation according to the ciphertext verification code, the fifth element, the transmitting-terminal session key, and the key length to calculate a symmetric encryption key length and a message authentication code key length.

7. The Bluetooth transmitting device of claim 6, wherein the encrypting and decrypting circuit is further configured to execute a symmetric encryption calculation according to the symmetric encryption key length and a plaintext to calculate a ciphertext data, wherein the encrypting and decrypting circuit is further configured to execute a message authentication code calculation according to the message authentication code key length and the ciphertext data to calculate a message authentication code, wherein the encrypting and decrypting circuit is further configured to calculate the ciphertext according to the ciphertext verification code, the ciphertext data, and the message authentication code.

8. The Bluetooth transmitting device of claim 1, wherein the transmitting-terminal algorithm identifier comprises an address of the Bluetooth transmitting device, and the receiving-terminal algorithm identifier comprises an address of the Bluetooth receiving device corresponding to the Bluetooth transmitting device.

9. A Bluetooth receiving device, comprising:
a key generating circuit, configured to generate a transmitting-terminal algorithm identifier, a receiving-terminal algorithm identifier, a public key, and a key length;
a calculating circuit, configured to generate a receiving-terminal authentication token, and receive a transmitting-terminal authentication token of a Bluetooth transmitting device to determine whether the transmitting-terminal authentication token is within an additive cyclic group, wherein if the transmitting-terminal authentication token is within the additive cyclic group, the calculating circuit is further configured to calculate a receiving-terminal session key according to the transmitting-terminal algorithm identifier, the receiving-terminal algorithm identifier, the transmitting-terminal authentication token, the receiving-terminal authentication token, and the key length;
a storing circuit, configured to store the receiving-terminal session key; and
an encrypting and decrypting circuit, configured to receive a ciphertext verification code of a ciphertext of the Bluetooth transmitting device to determine whether the ciphertext verification code is within the additive cyclic group, wherein if the ciphertext verification code is within the additive cyclic group, the encrypting and decrypting circuit is further configured to generate an encryption and decryption key and an address key according to the ciphertext verification code, the receiving-terminal session key, and the key length, wherein the encrypting and decrypting circuit is further configured to generate a plaintext and a data verification value respectively according to the encryption and decryption key and the address key, wherein if the encrypting and decrypting circuit determines that the data verification value is equal to a data check digit of the ciphertext, the encrypting and decrypting circuit outputs the plaintext.

10. The Bluetooth receiving device of claim 9, wherein the calculating circuit is further configured to generate a receiving-terminal random number, and execute a cryptographic hash function calculation according to the transmitting-terminal algorithm identifier, a first generator, and the public key to calculate a first parameter, wherein the calculating circuit is further configured to calculate the receiving-terminal authentication token according to the receiving-terminal random number and the first parameter.

11. The Bluetooth receiving device of claim 10, wherein the key generating circuit is further configured to generate a receiving-terminal master private key, wherein the calculating circuit is further configured to execute a bilinear pairing calculation according to the transmitting-terminal authentication token and the receiving-terminal master private key to calculate a first element, execute the bilinear pairing calculation according to the public key, a second generator, and the receiving-terminal random number to calculate a second element, and calculate a third element according to the first element and the receiving-terminal random number, wherein the calculating circuit is further configured to execute a key derivation calculation according to the transmitting-terminal algorithm identifier, the receiving-terminal algorithm identifier, the transmitting-terminal authentication token, the receiving-terminal authentication token, the first element, the second element, the third element, and the key length to calculate the receiving-terminal session key.

12. The Bluetooth receiving device of claim 11, wherein the encrypting and decrypting circuit is configured to execute the bilinear pairing calculation according to the ciphertext verification code and the master private key to calculate a fourth element, wherein the encrypting and decrypting circuit is further configured to generate the encryption and decryption key and the address key according to the ciphertext verification code, the fourth element, the receiving-terminal session key, and the key length.

13. The Bluetooth receiving device of claim 9, wherein the receiving-terminal algorithm identifier comprises an address of the Bluetooth receiving device, and the transmitting-terminal algorithm identifier comprises an address of the Bluetooth transmitting device corresponding to the Bluetooth receiving device.

14. A Bluetooth pairing method, comprising:
generating a transmitting-terminal algorithm identifier by a Bluetooth transmitting device, generating a receiving-terminal algorithm identifier by a Bluetooth receiving device, and generating a public key and a key length by the Bluetooth transmitting device and the Bluetooth receiving device;
calculating a transmitting-terminal session key and a receiving-terminal session key respectively by the Bluetooth transmitting device and the Bluetooth receiving device according to the transmitting-terminal algorithm identifier, the receiving-terminal algorithm identifier, a transmitting-terminal authentication token, a receiving-terminal authentication token, and the key length;
calculating a ciphertext according to the transmitting-terminal session key, the public key, and the key length by the Bluetooth transmitting device;
generating an encryption and decryption key and an address key according to a ciphertext verification code of the ciphertext, the receiving-terminal session key, and the key length by the Bluetooth receiving device;
generating a plaintext and a data verification value according to the encryption and decryption key and the address key respectively by the Bluetooth receiving device; and
if the data verification value is equal to a data check digit of the ciphertext, outputting the plaintext by the Bluetooth receiving device.

15. The Bluetooth pairing method of claim 14, further comprising:
generating a transmitting-terminal random number, and executing a cryptographic hash function calculation according to the receiving-terminal algorithm identifier, a first generator, and the public key to calculate a first parameter by the Bluetooth transmitting device;
calculating the transmitting-terminal authentication token according to the transmitting-terminal random number and the first parameter by the Bluetooth transmitting device;
generating a receiving-terminal random number, and executing the cryptographic hash function calculation according to the transmitting-terminal algorithm identifier, the first generator, and the public key to calculate a second parameter by the Bluetooth receiving device; and
calculating the receiving-terminal authentication token according to the receiving-terminal random number and the second parameter by the Bluetooth receiving device.

16. The Bluetooth pairing method of claim 15, further comprising:
generating a transmitting-terminal master private key by the Bluetooth transmitting device, and generating a receiving-terminal master private key respectively by the Bluetooth receiving device;
executing a bilinear pairing calculation according to the public key, a second generator, and the transmitting-terminal random number to calculate a first element, executing the bilinear pairing calculation according to the receiving-terminal authentication token and the transmitting-terminal master private key to calculate a second element, and calculating a third element according to the second element and the transmitting-terminal random number by the Bluetooth transmitting device; and
executing the bilinear pairing calculation according to the transmitting-terminal authentication token and the receiving-terminal master private key to calculate a fourth element, executing the bilinear pairing calculation according to the public key, the second generator, and the receiving-terminal random number to calculate a fifth element, and calculating a sixth element according to the fourth element and the receiving-terminal random number by the Bluetooth receiving device.

17. The Bluetooth pairing method of claim 16, wherein calculating the transmitting-terminal session key and the receiving-terminal session key respectively according to the transmitting-terminal algorithm identifier, the receiving-terminal algorithm identifier, the transmitting-terminal authentication token, the receiving-terminal authentication token, and the key length by the Bluetooth transmitting device and the Bluetooth receiving device comprises:
executing a key derivation calculation according to the transmitting-terminal algorithm identifier, the receiving-terminal algorithm identifier, the transmitting-terminal authentication token, the receiving-terminal authentication token, the first element, the second element, the third element, and the key length to calculate the transmitting-terminal session key by the Bluetooth transmitting device; and
executing the key derivation calculation according to the transmitting-terminal algorithm identifier, the receiving-terminal algorithm identifier, the transmitting-terminal authentication token, the receiving-terminal authentication token, the fourth element, the fifth element, the sixth element, and the key length to calculate the receiving-terminal session key by the Bluetooth receiving device.

18. The Bluetooth pairing method of claim 17, further comprising:
executing the cryptographic hash function calculation according to the transmitting-terminal session key, the first generator, and the public key to calculate a third parameter by the Bluetooth transmitting device;
generating an encrypting and decrypting random number, and calculating the ciphertext verification code according to the encrypting and decrypting random number and the third parameter by the Bluetooth transmitting device;
executing the bilinear pairing calculation according to the public key and the second generator to calculate a seventh element, and calculating an eighth element according to the seventh element and the encrypting and decrypting random number by the Bluetooth transmitting device;
calculating the key length according to a plaintext data length and a message authentication code length by the Bluetooth transmitting device; and
executing the key derivation calculation according to the ciphertext verification code, the eighth element, the transmitting-terminal session key, and the key length to calculate a symmetric encryption key length and a message authentication code key length by the Bluetooth transmitting device.

19. The Bluetooth pairing method of claim 18, further comprising:
executing a symmetric encryption calculate according to the symmetric encryption key length and the plaintext to calculate a ciphertext data by the Bluetooth transmitting device;
executing a message authentication code calculation according to the message authentication code key length and the ciphertext data to calculate a message authentication code by the Bluetooth transmitting device; and
calculating the ciphertext according to the ciphertext verification code, the ciphertext data, and the message authentication code by the Bluetooth transmitting device.

20. The Bluetooth pairing method of claim 19, wherein generating the encryption and decryption key and the address key according to the ciphertext verification code of the ciphertext, the receiving-terminal session key, and the key length by the Bluetooth receiving device comprises:
executing the bilinear pairing calculation according to the ciphertext verification code of the ciphertext and the master private key to calculate a ninth element by the Bluetooth receiving device; and
generating the encryption and decryption key and the address key according to the ciphertext verification code, the ninth element, the receiving-terminal session key, and the key length by the Bluetooth receiving device.
